(19) United States
(12) Patent Application Publication
(10) Pub. No.: US 2024/0314190 A1
(43) Pub. Date: Sep. 19, 2024

(54) TELEPRESENCE DEVICES, SYSTEMS AND METHODS

(71) Applicant: AMGEN INC., Thousand Oaks, CA (US)

(72) Inventors: Tyler Bellenfant, Thousand Oaks, CA (US); Jeremy S. Conner, Newbury Park, CA (US); Sarah Whetstone, Thousand Oaks, CA (US); Thomas Clark Pearson, Newbury Park, CA (US)

(21) Appl. No.: 18/577,109

(22) PCT Filed: Jul. 20, 2022
(86) PCT No.: PCT/US22/37663

§ 371 Date: Jan. 5, 2024

Related U.S. Application Data
(60) Provisional application No. 63/224,912, filed on Jul. 23, 2021.

(51) Int. Cl. H04L 65/80; H04N 21/236; H04N 21/472; H04N 23/62; H04N 23/661

(52) U.S. Cl. CPC H04L 65/80; H04N 21/236; H04N 21/472; H04N 23/62; H04N 23/661

(57) ABSTRACT

A telepresence system may include at least one telepresence device including a digital camera having camera control inputs and a video feed output. The system may also include at least one remote device having a web browser. The camera control inputs may be communicated from the remote device to the at least one telepresence device via an embedded webserver. The video feed output may be communicated to the remote device via a video server configured to transmit real-time video data from the digital camera, over a secure socket connection, to the remote device.

### CROSS-REFERENCE TO RELATED APPLICATION

Priority is claimed to U.S. Provisional Patent Application No. 63/224,912, filed Jul. 23, 2021, the entire contents of which are hereby incorporated by reference herein.

### FIELD OF DISCLOSURE

The present disclosure generally relates to telepresence devices, systems and methods for biopharmaceutical processes and applications. More particularly, the present disclosure relates to telepresence device, systems, and methods having a digital camera with camera control data communicated from a remote device to a telepresence device via an embedded webserver and a video feed communicated from the telepresence device to the remote device via a video server.

### BACKGROUND

A multitude of processes exist and occur that require visual observation and inspection. These processes can range from staff training on non-networked manufacturing equipment, bioreactor experiment monitoring for foam levels, site acceptance testing of capital equipment, remote staff training, cross site technology transfers, and continuous operations pertaining to laboratory and production environments. These operations often require a worker's presence at various points in order to observe and provide inputs to a project at hand.

While there exists a plethora of commercial video and telepresence solutions available to fulfill a general need for remote viewing, none of the existing telepresence solutions are optimal for use cases where underlying telepresence information is confidential. Commercial product assessments have been conducted and found at least the following deficiencies in their solutions: 3rd party video storage of internal research, operations, and facilities, software licensing and fees, incompatibility with enterprise and internal networks, difficult mounting assemblies and cabling that can require facilities involvement, issues with mobility around the laboratory equipment, and device access only available through mobile device applications with no native web browser support.

Apparatuses, systems, and methods are needed for improving telepresence. Apparatuses, systems, and methods are also needed for improving security of underlying telepresence related information.

### SUMMARY

A telepresence system of the present disclosure may include at least one telepresence device including a digital camera having camera control inputs and a video feed output. The system may also include at least one remote device having a web browser. The camera control inputs may be communicated from the remote device to the at least one telepresence device via an embedded webserver. The video feed output from the digital camera may be communicated to the remote device via a video server configured to transmit real-time video data from the digital camera, over a secure socket connection, to the remote device.

In another embodiment, a telepresence device may include a digital camera having at least two control inputs selected from: a camera power input, a camera pan input, camera tilt input, and a camera focus input. The telepresence device may also include an embedded webserver configured to receive digital camera control commands from a user interface of a remote device and provide two-way asynchronous updates with digital camera information and parameters between the digital camera and the remote device. The telepresence device may further include a video server configured to transmit real-time video data from the digital camera, over a secure socket connection, to the remote device.

In a further embodiment, a non-transitory computer-readable medium may store computer-readable instructions that, when executed by one or more processors, may cause the one or more processors to communicate camera control data from a remote device to a telepresence device via an embedded webserver and to communicate video data from the telepresence device to the remote device via a video server. The computer-readable medium may include an embedded webserver that, when executed by a processor, may cause the processor to receive digital camera control commands from a user interface of a remote device and provide two-way asynchronous updates with digital camera information and parameters between a digital camera and the remote device. The computer-readable medium may also include a video server that, when executed by a processor, may cause the processor to transmit real-time video data from the digital camera, over a secure socket connection, to the remote device.

### BRIEF DESCRIPTION OF THE DRAWINGS

It is believed that the disclosure will be more fully understood from the following description taken in conjunction with the accompanying drawings. Some of the drawings may have been simplified by the omission of selected elements for the purpose of more clearly showing other elements. Such omissions of elements in some drawings are not necessarily indicated of the presence or absence of particular elements in any of the exemplary embodiments, except as may be explicitly delineated in the corresponding written description. Also, none of the drawings are necessarily to scale.

FIG. 1 depicts an example telepresence system;

FIG. 2A depicts a high-level block diagram of an example telepresence system;

FIG. 2B depicts a block diagram of an example stationary telepresence device;

FIG. 2C depicts a block diagram of an example stationary telepresence device;

FIG. 2D depicts an example method of implementing a stationary telepresence device;

FIG. 2E depicts an example mobile telepresence device;

FIG. 2F depicts a block diagram of an example mobile telepresence device;

FIG. 2G depicts an example method of implementing a mobile telepresence device;

FIG. 2H depicts a block diagram of an example remote device;

FIG. 2I depicts an example method of implementing a remote device;

FIGS. 3A and 3B depict an example stationary telepresence device;

FIGS. 4A-C depict various views of an example dome for a stationary telepresence device;

FIGS. 5A-C depict various views of an example housing for a stationary telepresence device;

FIGS. 6A-C depict various views of an example tilt camera mount;

FIGS. 7A-C depict various views of an example pan camera mount;

FIGS. 8A and 8B depict various views of an example mobile telepresence device;

FIGS. 8C and 8D depict various views of an example base for a mobile telepresence device;

FIGS. 9A-C depict various views of an example mast mount;

FIGS. 10A-C depict various views of an example pan tilt camera mount;

FIG. 11 depicts an example user interface for control of a stationary telepresence device;

FIG. 12 depicts an example user interface for control of a mobile telepresence device;

FIG. 13 depicts an example user interface from a mobile telepresence device;

FIG. 14 depicts an example user interface from a stationary telepresence device;

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercial feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

The telepresence devices of the present disclosure may provide a means for remote viewing of proprietary biopharmaceutical equipment, processes, experiments, and research at an enterprise scale. Two different telepresence devices are 1) a stationary rapidly deployable, battery operated, wireless pan tilt zoom camera that is designed to fit on a benchtop or tripod and 2) a mobile, driver-controlled robot used for remote observation of entire laboratories and manufacturing suites. Both allow for users to remotely control on a secured enterprise network. A user can perform remote observation of a multitude of areas and processes operating each device individually or concurrently with each other while using a web browser as the user interface—no app is necessary. The video may stay within an enterprise network, never using 3rd party/vendor servers and risking disclosure of proprietary information. Additionally, the video and hosting servers of both telepresence devices of the present disclosure may be designed for easy access for deployment of machine learning in future applications.

These two devices may provide an optimal telepresence solution for many biopharmaceutical applications. Both may allow for direct, remote observation of experimental factors that up until this point have required personnel on site to observe in-person to make process corrections due to lack of adequate sensors (bioreactor foam levels, visual verification of equipment humane machine interfaces status and alarms, etc.). The use of these devices may also allow the prevention of staff coming on site during off hours and weekends in order to visually verify process equipment and non-networked machines providing labor cost savings. Remote training of staff can be conducted during personnel restriction periods, or when staff are not able to visit the training site directly or efficiently. Remote telepresence devices may also enable remote Site Acceptance Testing/Factory Acceptance Testing with vendors when international travel is restricted or untimely to meet schedule demands. Direct observation of equipment for vendors to help trouble shoot issues in real time avoiding schedule delays of an in-person visit is also a capability these devices provide. This may all be done without exposing proprietary information to 3rd party vendors or servers, reducing disclosure risk and allowing for rapid deployment in application areas that need it most.

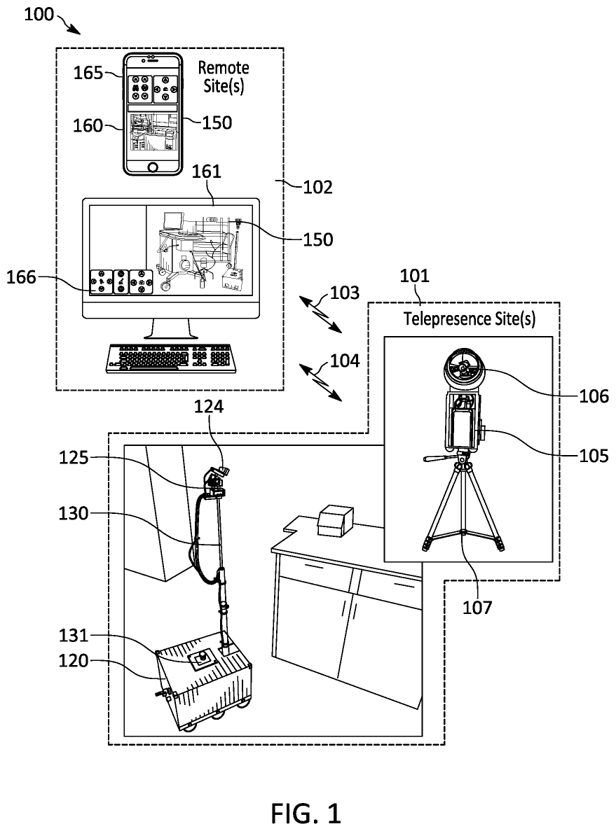

Turning to FIG. 1, a telepresence system 100 may integrate at least one telepresence site 101 with at least one remote site 102 via an embedded webserver 103 and a video server 104. The telepresence site 101 may include at least one stationary telepresence device 105 having a digital camera 106. The stationary telepresence device 105 may be mounted on, for example, a tri-pod 107. The telepresence site 101 may also include at least one mobile telepresence device 120 having; an emergency stop 131, and a digital camera 124 mounted to a mast 130 via a pan/tilt mechanism 125.

The remote site 102 may include at least one remote device 150 having, for example, a web browser based user interface having a stationary telepresence device control interface 165, a video feed from a stationary telepresence device 160, a mobile telepresence device control interface 166, or a video feed from a mobile telepresence device 161.

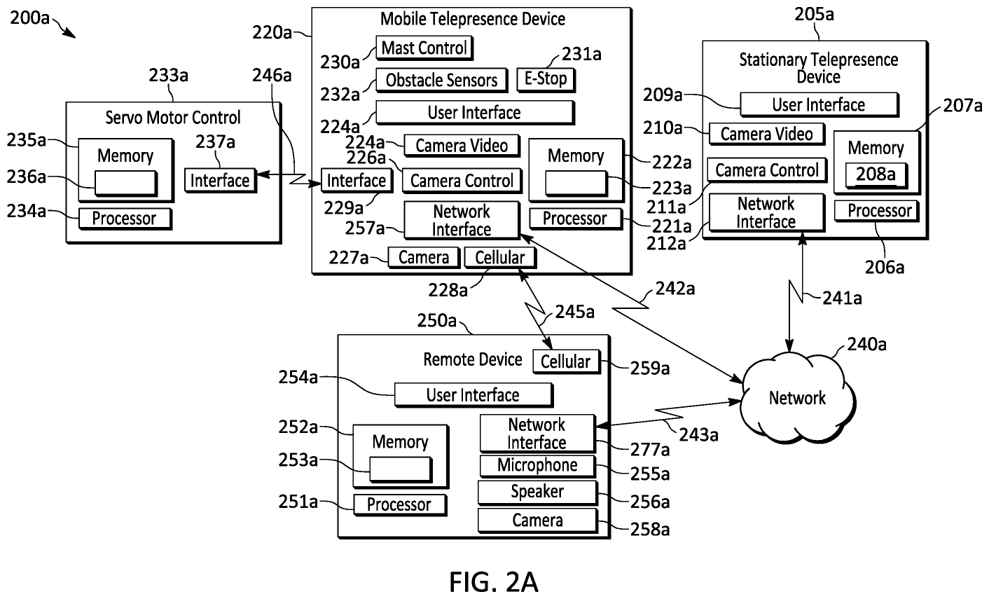

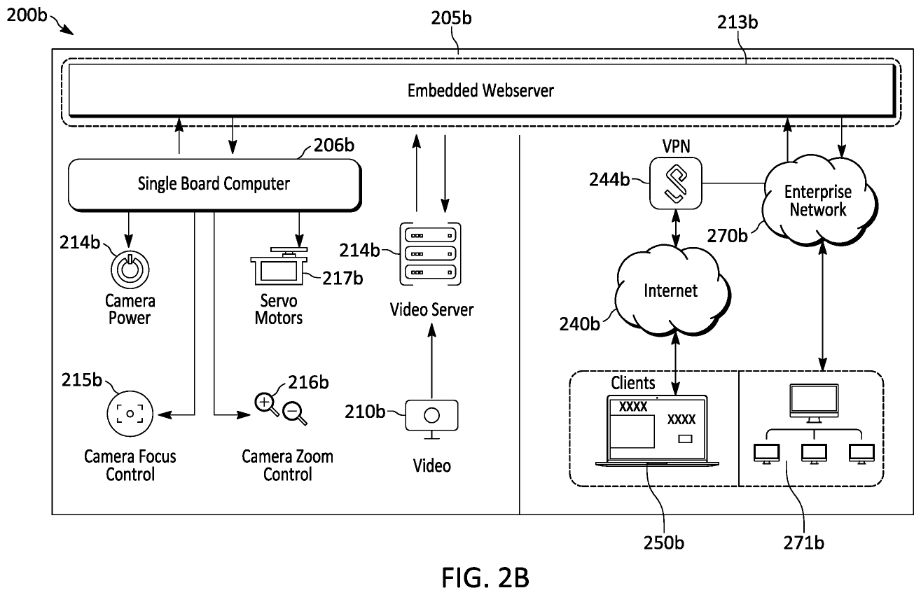

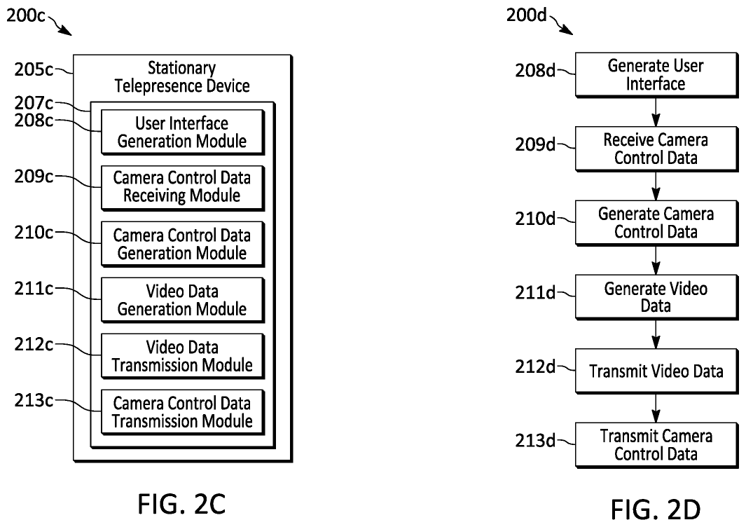

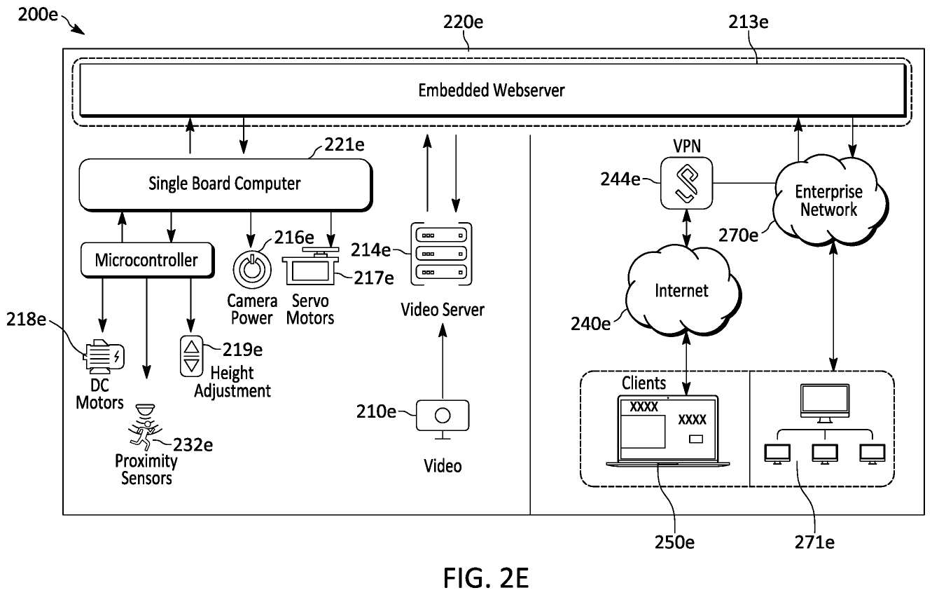

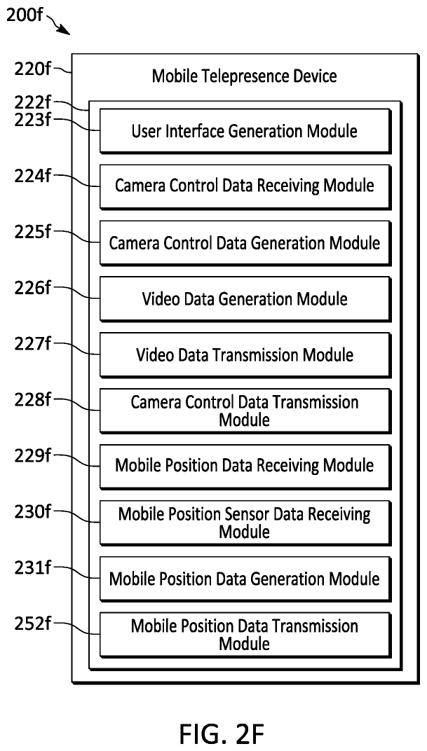

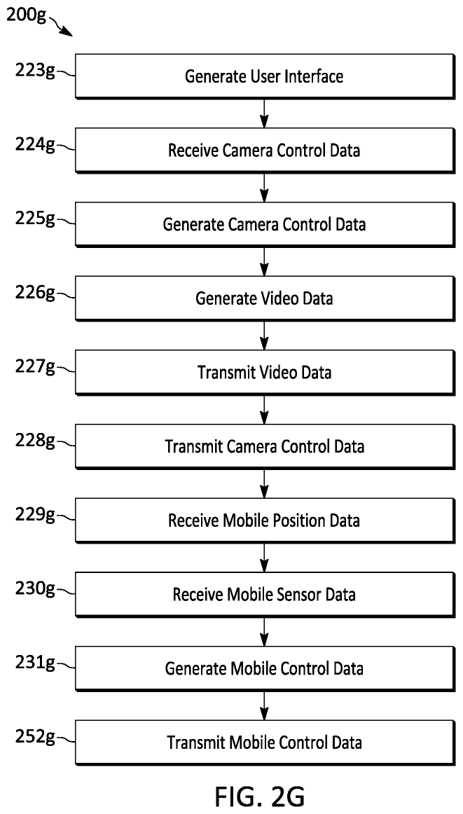

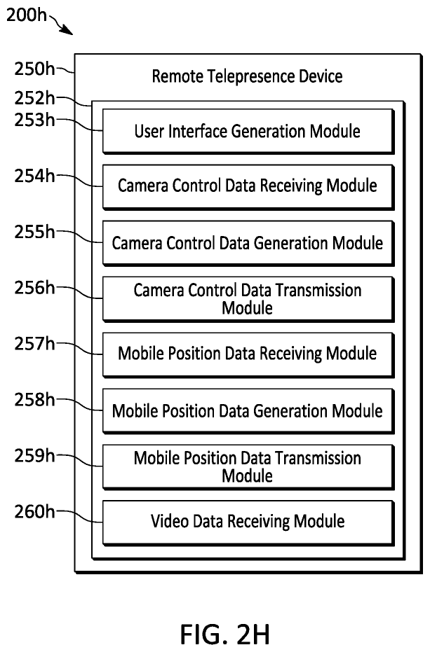

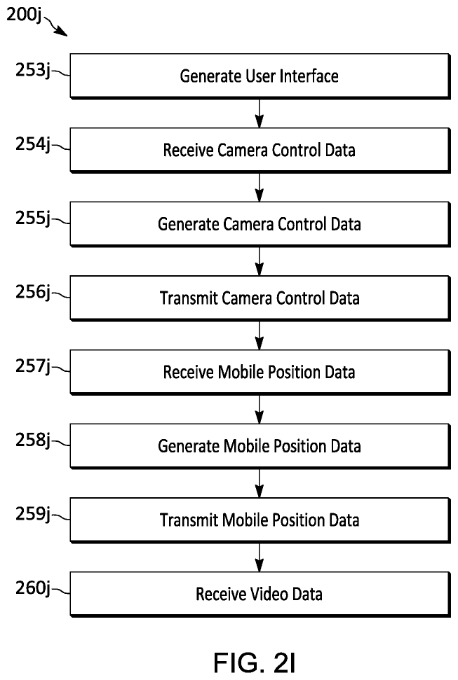

With reference to FIG. 2A, a telepresence system 200a may include a stationary telepresence device 205a, a mobile telepresence device 220a, and a remote device 250a communicatively interconnected via a network 240a. The telepresence system 200a may be similar to, for example, the telepresence system 100 of FIG. 1. The stationary telepresence device 205a may be similar to, for example, the stationary telepresence device 105. The mobile telepresence device 220a may be similar to, for example, the mobile telepresence device 120 of FIG. 1. The remote device 250a may be similar to, for example, the remote device 150 of FIG. 1.

For clarity, only one stationary telepresence device 205a, one mobile telepresence device 220a, and one remote device 250a are depicted in FIG. 2A. While FIG. 2A depicts only one stationary telepresence device 205a, one mobile telepresence device 220a, and one remote device 250a, it should be understood that any number of stationary telepresence devices 205a, mobile telepresence devices 220a, and remote devices 250a may be supported by the telepresence system 200a.

A stationary telepresence device 205a may include a memory 207 a and a processor 206a for storing and executing, respectively, a module 208a. The module 208a, stored in the memory 207a as a set of computer-readable instructions, may be related to an application for implementing at least a portion of the telepresence system 200a. As described in detail herein, the processor 206a may execute the module 208a to, among other things, cause the processor 206a to receive, generate, and/or transmit data (e.g., camera control data, mobile base control data, video data, etc.) with the remote device 250a.

The stationary telepresence device 205a may also include a user interface 209a which may be any type of electronic display device, such as touch screen display, a liquid crystal display (LCD), a light emitting diode (LED) display, a plasma display, a cathode ray tube (CRT) display, or any other type of known or suitable electronic display along with a user input device. A user interface 209a may exhibit a user interface display (e.g., any user interface 160, 161, 165, 166 of FIG. 1, etc.) which may, for example, depict a user interface for implementation of at least a portion of the telepresence system 200a.

The stationary telepresence device 205a may also include camera video 210a, camera control 211a, and a network interface 212a configured to, for example, facilitate communications, for example, between the stationary telepresence device 205a and the network device 240a via any wireless communication network 241a, including for example: a wireless LAN, MAN or WAN, WiFi, TLS v1.2 WiFi, the Internet, or any combination thereof. Moreover, a stationary telepresence device 205a may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

A stationary telepresence device may include: a compact design for fitting on a laboratory bench top or other confined space; web browser user interface—no app required; supports multiple concurrent users with session management features; video feed stays internal to enterprise network—no vendor/3rd party storage or transmission; tripod mounting hardware for manufacturing floor placement; additive manufacturing processes for the device housing for rapid manufacturing; dual operational modes: observer and controller; HTML video element allows for canvas element overlay for machine learning applications; pan/tilt/zoom camera; compatible with secured enterprise network; full day battery life, with the option to run plugged into a power source to run indefinitely; “Picture-in-picture” feature allows for long term remote monitoring, etc.

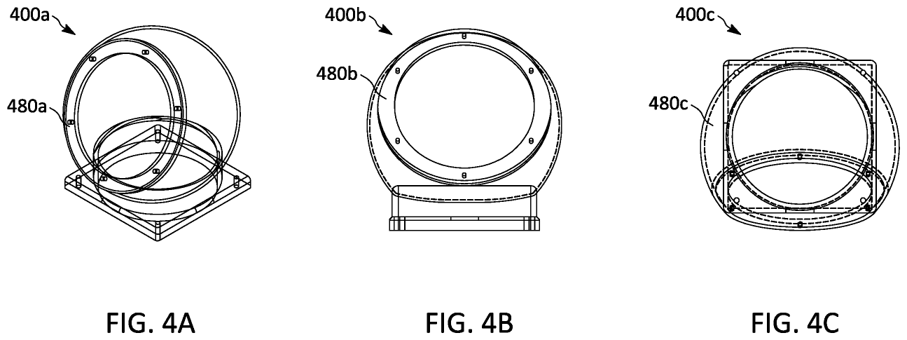

The stationary remote presence device may include physical, electrical, and software architecture. The physical architecture is comprised of a custom designed 3-D printed housing, dome, and tilt and pan camera mounting assemblies (FIGS. 4A7C), respectively). The 3-D printed parts can be manufactured out of a variety of materials such Acrylonitrile butadiene styrene (ABS) or polylactide depending on the desired material properties for rigidity and thermal tolerance. Laser cut acrylic side paneling provides the structural sides of the device, with openings to allow for a charging cable and pressing the power button. A vacuum formed clear acrylic dome is mounted in front of the camera for protection of the lens. The main electrical components are a rechargeable lithium ion battery, a single board computer, a servo motor controller board, a camera zoom and camera focus motor control board, four distinct motors, and a camera sensor with a variable zoom lens. The battery provides power for the single board computer, the motor control boards, the motors, and the camera sensor and processor. The single board computer hosts custom software for enabling two separate webservers, the signaling functionality for HD video streaming, the logic and commands for controlling the motors and camera and managing user sessions. A high-level diagram of the software architecture can be seen in FIG. 2B.

The two webservers are responsible for most of the functionality of the device. The embedded webserver is written in the Python programming language using the micro web framework Flask. The embedded webserver uses standard HTTP requests to receive commands from the user interface, and additionally uses persistent WebSocket connections with the client to provide two-way asynchronous updates with device information and parameters. It is also responsible for serving the user interface as a webpage to the client. The user interface has two modes of operation: an observation mode and a controller mode. A user in observation mode will have access to the video feed, but none of the camera controls. A user in controller in mode has full access to the pan, tilt, zoom and focus controls of the camera. The device only allows for one controller at a time but allows for multiple observers. In addition to the embedded webserver, there is a video server that handles and negotiates the connections and distribution of the video feed to multiple users. The video server uses Node.js, which is a cross-platform, back-end, JavaScript runtime environment that executes JavaScript code to enable real time transmission of data over secure socket connections including, as one example, encrypted socket connections. A secure socket connection may incorporate a standard security technology for establishing, for example, an encrypted link between a server and a client (e.g., a link to communicate video data from a telepresence device to a remote device via a video server, etc.). A secure socket connection may be established via, for example, a secure sockets layer (SSL), a secure shell (SSH), transport layer security (TLS), etc. A secure socket connection as such may include an encrypted socket connection.

There is a broadcast functionality in the Node server that captures the raw data from the camera sensor and handles the multiplexing and encoding of the video feed to multiple clients. The client functionality in the node server accepts requests from the broadcaster and then ports the video to the user interface. The servers are both hosted on the single board computer and provide instructions to its interfaces, including the I2C communication bus that sends instructions to the motor controllers for the camera pan, tilt, zoom and focus functionality. The single board computer also has a Camera Serial Interface (CSI) that the data from the camera image sensor is received through and then is further encoded for video transmission. All communication between the servers and the users are encrypted using authenticated and secure connections on a secure socket layer (SSL) using enterprise computer system security certificates.

A mobile telepresence device 220a may include a memory 222a and a processor 221a for storing and executing, respectively, a module 223a. The module 223a, stored in the memory 222a as a set of computer-readable instructions, may be related to an application for implementing at least a portion of the telepresence system 200a. As described in detail herein, the processor 221a may execute the module 223a to, among other things, cause the processor 221a to receive, generate, and/or transmit data (e.g., camera control data, mobile base control data, video data, etc.) with the remote device 250a.

The mobile telepresence device 220a may also include a user interface 224a which may be any type of electronic display device, such as touch screen display, a liquid crystal display (LCD), a light emitting diode (LED) display, a plasma display, a cathode ray tube (CRT) display, or any other type of known or suitable electronic display along with a user input device. A user interface 224a may exhibit a user interface display (e.g., any user interface 160, 161, 165, 166, of FIG. 1, etc.) which may, for example, depict a user interface for implementation of at least a portion of the telepresence system 200a.

The mobile telepresence device 220a may also include camera video 224a, camera control 226a, at least one obstacle sensor 232a, an emergency stop button 231a, a mast height control 230a, a camera 227a, a network interface 257a, an interface 229a, and a cellular interface 228a. The network interface 257a may be configured to facilitate communications (e.g., camera control data, mobile base control data, video data, etc.), for example, between the mobile telepresence device 220a and the network device 240a via any wireless communication network 242a, including for example: TLS v1.2 WiFi, a wireless LAN, MAN or WAN, WiFi, the Internet, or any combination thereof. Moreover, a mobile telepresence device 220a may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

The interface 228a may be configured to facilitate communications, for example, between the mobile telepresence device 220a and the servo motor control 233 via any wireless communication network 246a, including for example: a Bluetooth link, a wireless LAN, MAN or WAN, WiFi, TLS v1.2 WiFi, the Internet, or any combination thereof. Additionally, or alternatively, a mobile telepresence device 220a may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

The cellular interface 259a may be configured to facilitate communications (e.g., audio data, video data, etc.), for example, between the remote device 250a and the healthcare provide device 280a via any wireless communication network 246a, including for example: TLS v1.2 Cellular, a wireless LAN, MAN or WAN, WiFi, TLS v1.2 WiFi, the Internet, or any combination thereof. Moreover, a remote device 250a may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

The servo motor control 233a may include a processor 234a, a memory 235a for storing and executing, respectively, a module 236a. The module 236a, stored in the memory 235a as a set of computer-readable instructions, may be related to an application for implementing at least a portion of the telepresence system 200a. As described in detail herein, the processor 234a may execute the module 236a to, among other things, cause the processor 234a to receive, generate, and/or transmit data (e.g., camera control data, mobile base control data, video data, etc.) with the remote device 250a.

The servo motor control 233a may also include an interface 237a. The interface 237a may be configured to facilitate communications, for example, between the servo motor control 233a and the mobile telepresence device 220a via any wireless communication network 259a, including for example: a Bluetooth link, a wireless LAN, MAN or WAN, WiFi, TLS v1.2 WiFi, the Internet, or any combination thereof. Additionally, or alternatively, a sensor device 240a may be communicatively connected to any other device via any suitable communication system, such as via any publicly available or privately owned communication network, including those that use wireless communication structures, such as wireless communication networks, including for example, wireless LAN and WANs, satellite and cellular telephone communication systems, etc.

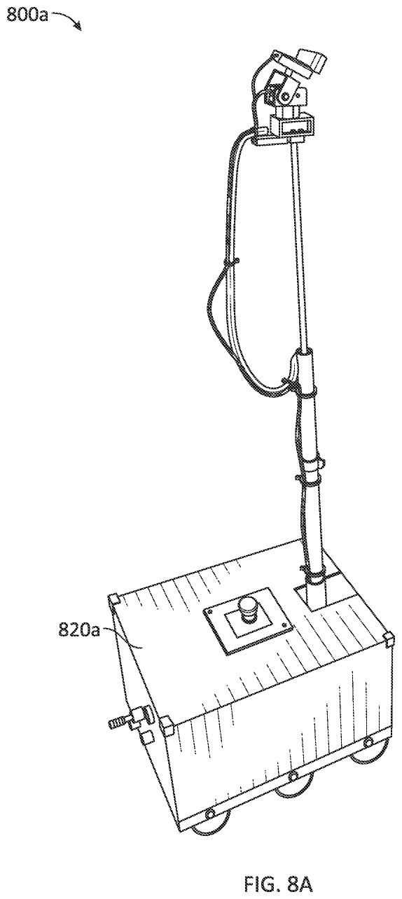

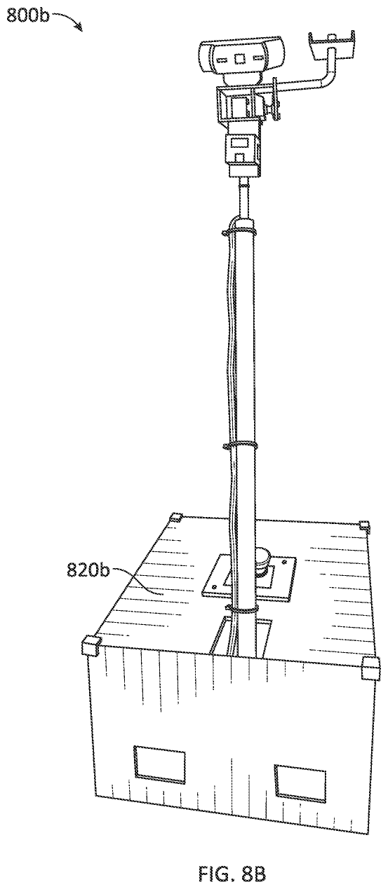

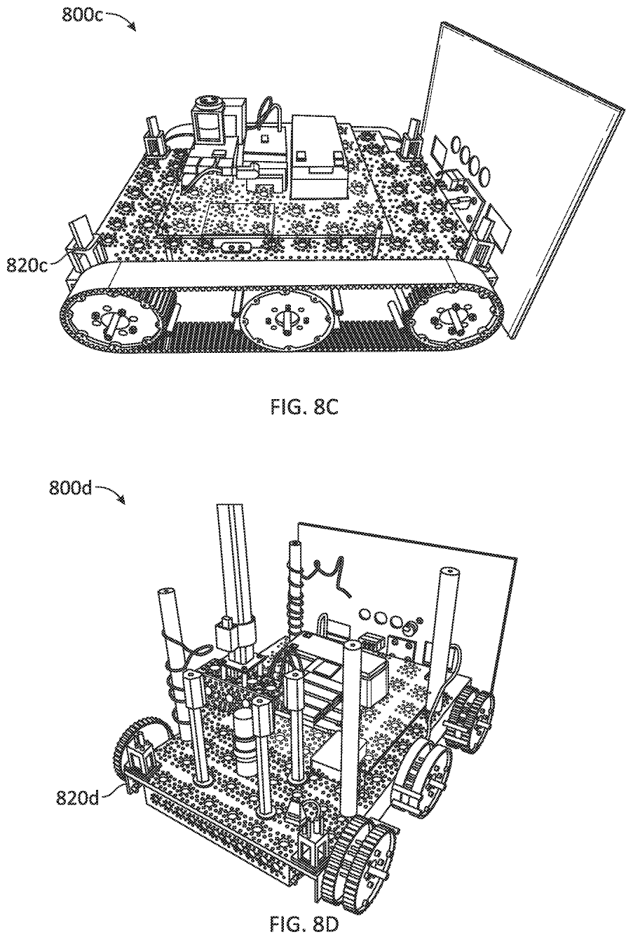

The mobile telepresence device covered herein (shown in FIGS. 8A-D) may include: a compact design for navigating around tight laboratory and production aisles; a web browser user interface for driving and camera controlling—no app required; supports multiple concurrent users with session management features; video feed stays internal to enterprise network—no vendor/3rd party storage or transmission; robust chassis and tracks for maneuvering over laboratory equipment; additive manufacturing processes for the device housing for rapid manufacturing; dual operational modes: observer and controller; HTML video element allows for canvas element overlay for machine learning applications; pan/tilt camera; height adjustable mast through web browser; compatible with secured enterprise network; full day battery life, with ability to wirelessly charge at its charging station; “Picture-in-picture” feature allows for long term remote monitoring; etc.

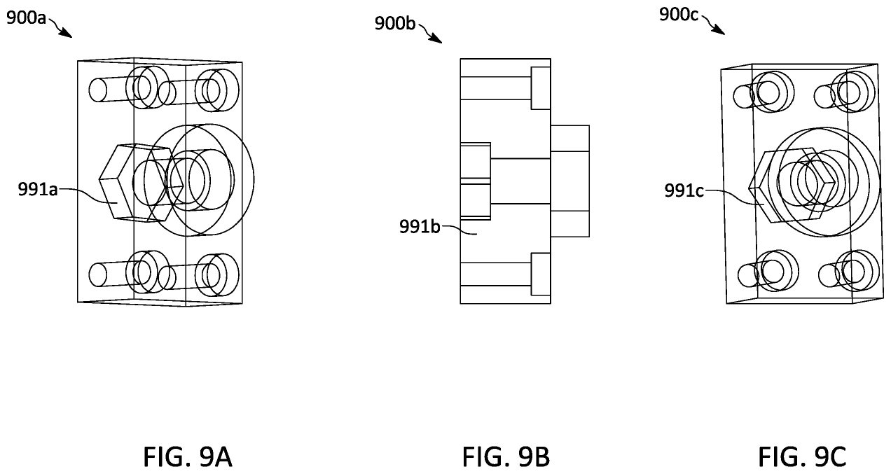

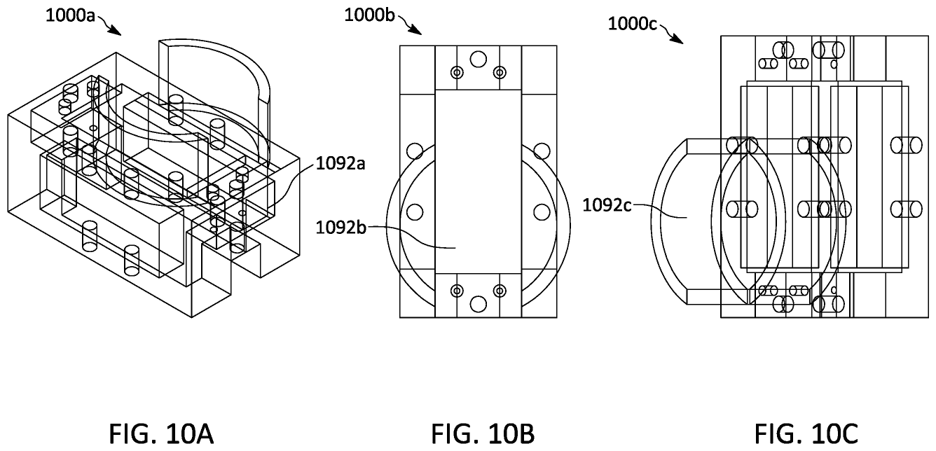

The mobile remote presence device may include physical, electrical, software, and firmware architecture. The physical architecture may include an aluminum chassis and supports, two tracks, custom designed 3-D printed tilt and pan camera mounting assemblies (shown in FIGS. 9A-10C), and laser cut acrylic housing. The aluminum base and drive track system of the robot may allows for a robust base and high maneuverability to navigate around laboratory equipment and aisles. Similar to the stationary remote telepresence, the 3-D printed mounting parts can be manufactured out of an ABS or polylactide material and the acrylic side paneling provides the structural sides and roof of the robot.

The main electrical components of the mobile robotic telepresence consist of a 12V rechargeable lithium ion battery, a single board computer, a servo motor controller board, two servo motors, a microcontroller, a wiring board, three DC motors, two dual motor driver boards, four Time-of-Flight distance sensors, and an USB camera (FIGS. 8C and 8D). The electrical components for the software architecture (i.e. battery, single board computer, servo motor boards and servo motors, and camera) are set up similarly and provide the same functionality as in the stationary device discussed in the previous section. In addition to the single board computer hosting custom software for enabling two separate webservers, video streaming, camera commands, and user session management, it also communicates movement commands to the microcontroller. The firmware architecture may provide low-level control for the driving and mast motors and integrates safety features such as automatically stopping when the Time-of-Flight sensors are triggered. The mobile remote telepresence high-level diagram of the software architecture only differs from the stationary architecture with its added microcontroller and does not include the zoom/focus camera controls, as seen in FIG. 2E.

Like the stationary telepresence, the mobile's two webservers are primarily responsible for the functionality of the device, besides the safety features implemented in the firmware. The embedded webserver is written in Python and uses the micro web framework Flask. The embedded webserver uses standard HTTP requests to receive commands from the user interface, and additionally uses persistent WebSocket connections with the client to provide two-way asynchronous updates with device information and parameters. The connections are also responsible for serving the user interface as a webpage to the client. The user interface has two modes of operation: an observation mode and a controller mode. A user in observation mode will have access to the video feed, but none of the camera or movement controls. A user in controller mode has full access to the camera pan and tilt controls, mast height adjustment controls, and driver directional movement. The device restricts to one controller at a time but allows for multiple observers. Similarly to the stationary device, there is also a video server that handles and negotiates the connections and distribution of the video feed to its users. Functioning in the same way as described in the previous section, the video server uses Node.js to broadcast the video feed to multiple clients. The embedded webserver and video server are both hosted on the single board computer and provide instructions to its interfaces, including the I2C communication bus that sends instructions to the microcontroller for movement control and the motor board for the camera pan and tilt functionality. The single board computer also has a Camera Serial Interface (CSI) that the data from the camera image sensor is received through and then is further encoded for video transmission. Unique to these devices compared to the current commercial products, all communication between the servers and the users are encrypted using authenticated and secure connections on a secure socket layer (SSL) using, for example, security certificates.

A remote device 250a may include a memory 252a and a processor 251a for storing and executing, respectively, a module 253a. The module 253a, stored in the memory 252a as a set of computer-readable instructions, may be related to an application for implementing at least a portion of the telepresence system 200a. As described in detail herein, the processor 251a may execute the module 253a to, among other things, cause the processor 251a to receive, generate, and/or transmit data (e.g., camera control data, mobile base control data, video data, etc.) with the network device 240a.

The remote device 250a may also include a user interface 254a which may be any type of electronic display device, such as touch screen display, a liquid crystal display (LCD), a light emitting diode (LED) display, a plasma display, a cathode ray tube (CRT) display, or any other type of known or suitable electronic display along with a user input device. A user interface 254a may exhibit a user interface display (e.g., any user interface 160, 161, 165, 166, of FIG. 1, etc.) which may, for example, depict a user interface for implementation of at least a portion of the telepresence system 200a.

The remote device 250a may also include a microphone 255a, a speaker 256a, a camera 258a, a network interface 277a, and a cellular interface 259a. The network interface 257a may be configured to facilitate communications (e.g., camera control data, mobile base control data, video data, etc.), for example, between the remote device 250a and the network device 240a via any wireless communication network 243a, including for example: TLS v1.2 REST API, TLS v1.2 Cellular, CSV/JSON Output, TLS v1.2 REST API, a wireless LAN, MAN or WAN, WiFi, TLS v1.2 WiFi, the Internet, or any combination thereof. Moreover, a remote device 250a may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

The cellular interface 259a may be configured to facilitate communications (e.g., audio data, video data, etc.), for example, between the remote device 250a and the telepresence device via any wireless communication network 246a, including for example: TLS v1.2 Cellular, a wireless LAN, MAN or WAN, WiFi, TLS v1.2 WiFi, the Internet, or any combination thereof. Moreover, a healthcare provider device 250a may be communicatively connected to any other device via any suitable communication system, such as via any publicly available or privately owned communication network, including those that use wireless communication structures, such as wireless communication networks, including for example, wireless LANs and WANs, satellite and cellular telephone communication systems, etc.

Turning to FIG. 2B, a telepresence system 200b may include a stationary telepresence device 205b having a single board computer 206b with an embedded webserver 213b and a video server 214b. The single board computer 206b may also include a camera power input 214b, a camera focus input 215b, a camera zoom input 216b, and a servo motor control 217b. The stationary telepresence device 205b may also include a video feed 210b. The telepresence system 200b may also include a remote device 250b connected to an enterprise network 270b via a virtual private network (VPN) 244b. The telepresence system 200b may also include a plurality of enterprise clients 271b.

Turning to FIG. 2C, a telepresence system 200d may include a stationary telepresence device 220d having a user interface generation module 208c, a camera control data receiving module 209c, a camera control data generation module 210c, a video data generation module 211c, a video data transmission module 212c, and a camera control data transmission module 213c, for example, stored on a memory 207c as a set of computer-readable instructions. In any event, the modules 208c-213c may be similar to, for example, the module 208a of FIG. 2A.

With reference to FIG. 2E, a method of implementing a telepresence device 200e may be implemented by a processor (e.g., processor 206a of FIG. 2A) executing, for example, at least a portion of modules 208c-213c of FIG. 2C. In particular, processor 206a may execute the user interface generation module 208c to cause the processor 206a to, for example, generate a user interface 160, 161, 165, 166 (block 208d).

The processor 206a may execute the camera control data receiving module 209c to cause the processor 206a to, for example, receive camera control data from a remote device 150 (block 209d). The processor 206a may execute the camera control data generation module 210c to cause the processor 206a to, for example, generate camera control data (block 210d). The processor 206a may execute the video data generation module 211c to cause the processor 216a to, for example, generate video data (block 211d). The processor 206a may execute the video data transmission module 212c to cause the processor 216a to, for example, transmit video data to a remote device 150 (block 212d). The processor 206a may execute camera control data transmission module 213c to cause the processor 206a to, for example, transmit camera control data to a remote device 150, 250a (block 213d).

With reference to FIG. 2E, a telepresence system 200e may include a mobile telepresence device 220e having a single board computer 221e with an embedded webserver 213e and a video server 214e. The single board computer 221e also includes a camera power input 214e and a servo motor control 217e. The mobile telepresence device 220e may also include a video feed 224e. The telepresence system 200e may also include a remote device 250e connected to an enterprise network 270e via a virtual private network (VPN) 244e. The telepresence system 200e may also include a plurality of enterprise clients 271e.

Turning to FIG. 2F, a telepresence system 200f may include a mobile telepresence device 220f having a user interface generation module 223f, a camera control data receiving module 224f, a camera control data generation module 225f, a video data generation module 226f, a video data transmission module 227f, a camera control data transmission module 228f, a mobile position data receiving module 229f, a mobile position sensor data receiving module 230f, a mobile position data generation module 231f, and a mobile position data transmission module 232f, for example, stored on a memory 222f as a set of computer-readable instructions. In any event, the modules 223f-232f may be similar to, for example, the module 223a of FIG. 2A.

With reference to FIG. 2G, a method of implementing a mobile telepresence device 200g may be implemented by a processor (e.g., processor 221a of FIG. 2A) executing, for example, at least a portion of modules 223f-232f of FIG. 2F. In particular, processor 221a may execute the user interface generation module 223f to cause the processor 221a to, for example, generate a user interface 160, 161, 165, 166 (block 223g).

The processor 221a may execute the camera control data receiving module 224f to cause the processor 221a to, for example, receive camera control data from a remote device 150, 250a (block 224g). The processor 221a may execute the camera control data generation module 225f to cause the processor 221a to, for example, generate camera control data (block 225g). The processor 221a may execute the video data generation module 226f to cause the processor 251a to, for example, generate video data (block 226g). The processor 221a may execute the video data transmission module 227f to cause the processor 221a to, for example, transmit video data to a remote device 150, 250a-c (block 227g).

The processor 221a may execute the camera control data transmission module 228f to cause the processor 221a to, for example, transmit camera control data to a remote device 150, 250a-c (block 228g). The processor 221a may execute the mobile position data receiving module 229f to cause the processor 221a to, for example, receive mobile position data from at least one obstacle sensor 232a (block 229g). The processor 221a may execute the mobile position sensor data receiving module 230f to cause the processor 221a to, for example, receive mobile position sensor data from an obstacle sensor 232a (block 230g).

The processor 221a may execute the mobile position data generation module 231f to cause the processor 251a to, for example, generate mobile position data (block 231g). The processor 221a may execute the mobile position data transmission module 232f to cause the processor 221a to, for example, transmit mobile position data to a remote device 150, 250a-c (block 232g).

Turning to FIG. 2H, telepresence system 200h may include a remote device 250h having a user interface generation module 253h, a camera control data receiving module 254h, a camera control data generation module 255h, a camera control data transmission module 256h, a mobile position data receiving module 257h, a mobile position data generation module 258h, a mobile position data transmission module 259h, and a video data receiving module 260h, for example, stored on a memory 252h as a set of computer-readable instructions. In any event, the modules 253h-260h may be similar to, for example, the module 253a of FIG. 2A.

With reference to FIG. 2I, a method of implementing a remote device 200j may be implemented by a processor (e.g., processor 251a of FIG. 2A) executing, for example, at least a portion of modules 253h-260h of FIG. 2H. In particular, processor 251a may execute the user interface generation module 253h to cause the processor 251a to, for example, generate a user interface 160, 161, 165, 166 (block 253j).

The processor 251a may execute the camera control data receiving module 254h to cause the processor 251a to, for example, receive camera control data from a stationary telepresence device 105, 205a-c and/or a mobile telepresence device 120, 220a,f (block 254j). The processor 251a may execute the camera control data generation module 255h to cause the processor 251a to, for example, generate camera control data (block 255j). The processor 251a may execute the camera control data transmission module 256h to cause the processor 251a to, for example, transmit camera control data to stationary telepresence device 105, 205a-c and/or a mobile telepresence device 120, 220a,f (block 256j).

The processor 251a may execute the mobile position data receiving module 257h to cause the processor 251a to, for example, receive mobile position data from a stationary telepresence device 105, 205a-c and/or a mobile telepresence device 120, 220a,f (block 257j). The processor 251a may execute the mobile position data generation module 258h to cause the processor 251a to, for example, generate mobile position data (block 258j). The processor 251a may execute the mobile position data transmission module 259h to cause the processor 251a to, for example, transmit mobile position data to a stationary telepresence device 105, 205a-c and/or a mobile telepresence device 120, 220a,f (block 259j). The processor 251a may execute the video data receiving module 260h to cause the processor 251a to, for example, receive video data from a stationary telepresence device 105, 205a-c and/or a mobile telepresence device 120, 220a,f (block 260j).

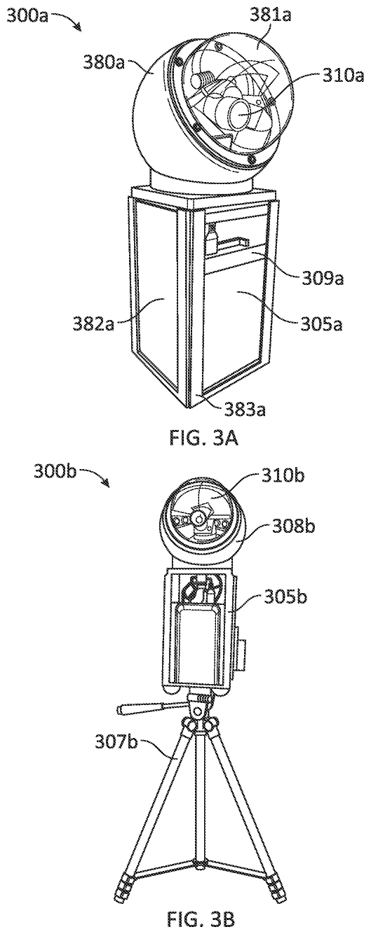

With reference to FIGS. 3A and 3B, a telepresence system 300a,b may include a stationary telepresence device 305a,b may include a camera 310a,b within a dome 380a,b having a clear shield 381a,b. The stationary telepresence device 300a,b may also include a housing 382a with frame 383a, and a user interface 309a,b. The stationary telepresence device 300a,b may be similar to, for example, the stationary telepresence device 105 of FIGS. 1 and/or 205a-c of FIG. 2A.

Turning to FIGS. 4A-C, a dome for a stationary telepresence device 400a-c may include a generally spherical shape 480a-c. The dome 480a-c may be similar to, for example, the dome 380a,b of FIGS. 3A and 3B, respectively.

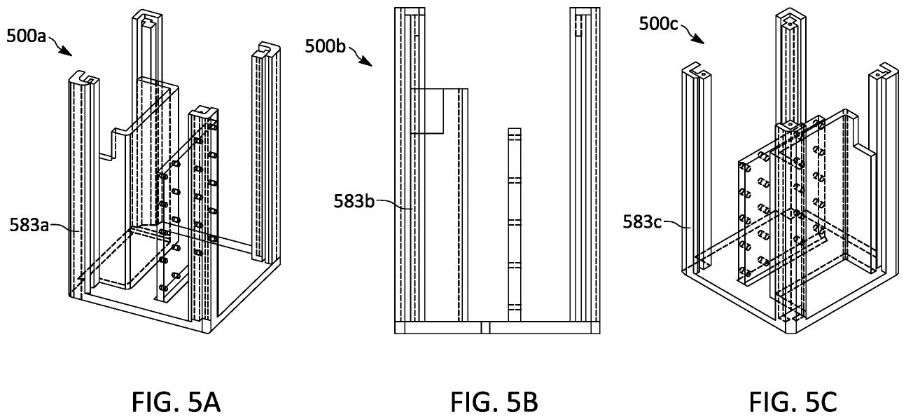

With reference to FIGS. 5A-C, a housing for a stationary telepresence device 500a-c may include a frame 583a-c. The housing 500a-c may be similar to, for example, the housing 382a of FIG. 3A.

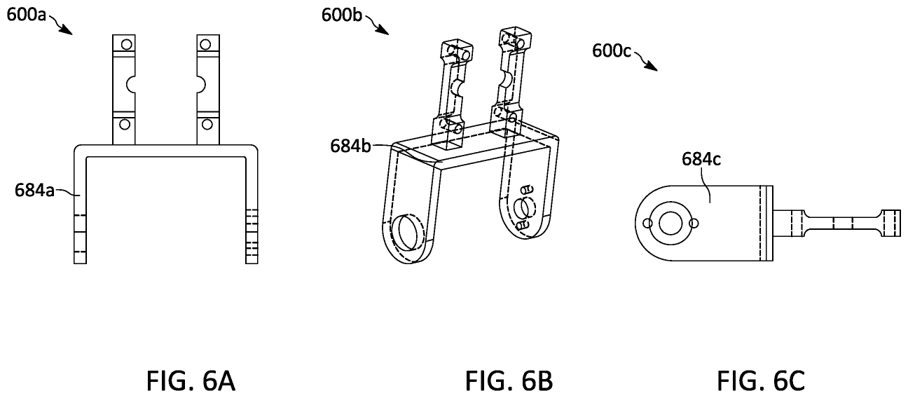

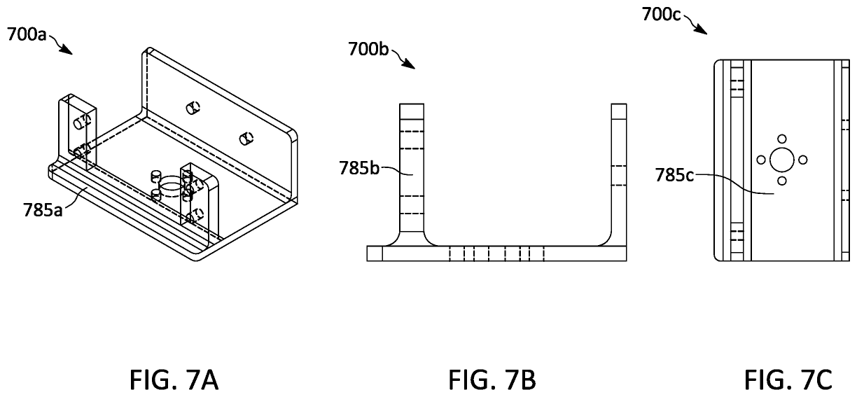

Turning to FIGS. 6A-C, a tilt camera mount 600a-c may include pivot 684a-c. The pivot mount 684a-c may be combine with the bracket 785a-c of FIG. 7A-C to form a camera tilt mechanism 125 of FIG. 1.

With reference to FIGS. 7A-C, a pan camera mount 700a-c may include bracket 785a-c. The bracket 785a-c may combine with the pivot mount 684a-c to form a camera tilt mechanism 125 of FIG. 1.

Turning to FIGS. 8A and 8B, a mobile telepresence device 800a,b may be remotely repositionable. The mobile telepresence device 800a,b may be similar to, for example, the mobile telepresence device 150 of FIG. 1 and/or the mobile telepresence device 250a-c of FIGS. 2A-C.

With reference to FIGS. 8C and 8D, a base for a mobile telepresence device 800c, d may be remotely repositionable. The mobile telepresence device 800c, d may be similar to, for example, the mobile telepresence device 150 of FIG. 1 and/or the mobile telepresence device 250a-c of FIGS. 2A-C.

Turning to FIGS. 9A-C, a mast mount 900a-c may be remotely repositionable. The mast mount 900a-c may combine with the pan tilt camera mount 1000a-c to define a camera pan tilt mechanism 125 of FIG. 1.

With reference to FIGS. 10A-C, a pan tilt camera mount 1000a-c may be remotely repositionable. The pan tilt camera mount 1000a-c may combine with the mast mount 900a-c to define a camera pan tilt mechanism 125 of FIG. 1.

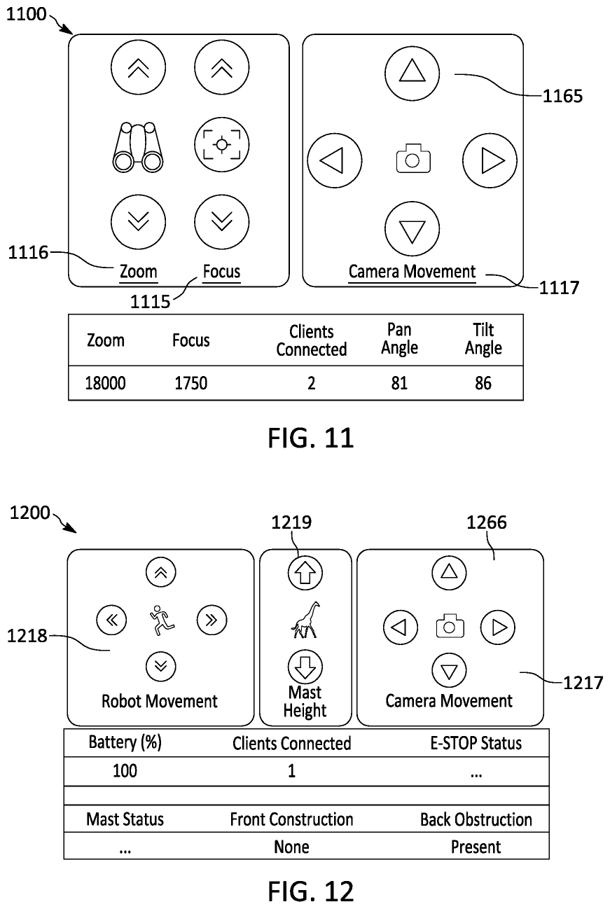

Turning to FIG. 11, a user interface 1165 for control of a stationary telepresence device 1100 may include a zoom 1116, a focus 1115, a camera movement mechanism 1117 with multi-function. The user interface 1100 may be similar to, for example, the user interface 165 of FIG. 1.

With reference to FIG. 12, a user interface 1266 for control of a mobile telepresence device 1200 may include a mobile base control 1218, a mast control 1219, and a camera movement control 1217. The user interface 1200 may be similar to, for example, the user interface 166 of FIG. 1.

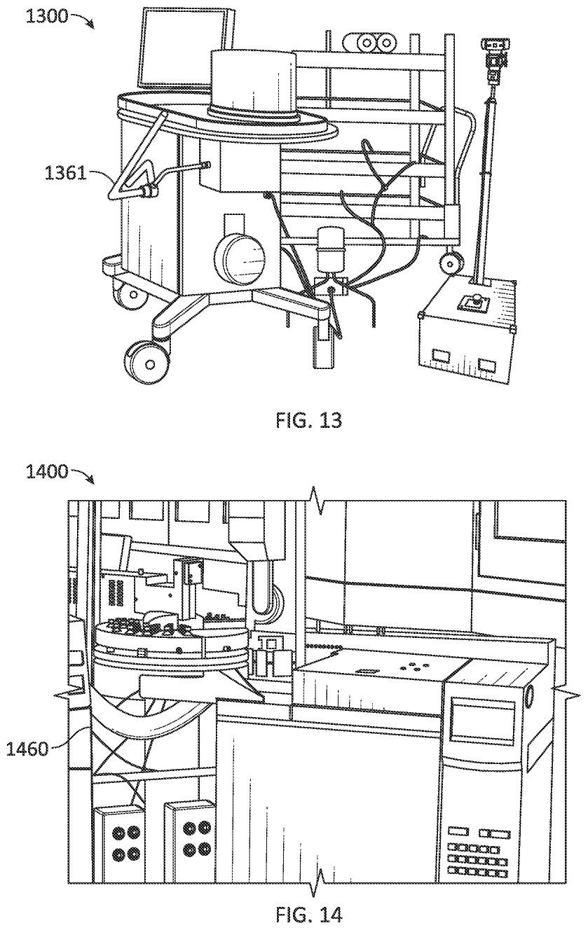

Turning to FIG. 13, a user interface from a mobile telepresence device 1300 may include a video feed 1361. The user interface 1300 may be similar to, for example, the user interface 160, 161 of FIG. 1.

With reference to FIG. 14, a user interface from a stationary telepresence device 1400 may include a video feed 1460. The user interface 1400 may be similar to, for example, the user interface 160, 161 of FIG. 1.

Although the devices, systems, assemblies, components, subsystems and methods have been described in terms of exemplary embodiments, they are not limited thereto. The detailed description is to be construed as exemplary only and does not describe every possible embodiment of the present disclosure. Numerous alternative embodiments could be implemented, using either current technology or technology developed after the filing date of this patent that would still fall within the scope of the claims defining the invention(s) disclosed herein.

Those skilled in the art will recognize that a wide variety of modifications, alterations, and combinations can be made with respect to the above described embodiments without departing from the spirit and scope of the invention(s) disclosed herein, and that such modifications, alterations, and combinations are to be viewed as being within the ambit of the inventive concept(s).

1. A telepresence system, comprising:
at least one telepresence device including a digital camera having camera control inputs and a video feed output; and
at least one remote device having a web browser, wherein the camera control inputs are communicated from the remote device to the at least one telepresence device via an embedded webserver, and wherein the video feed output is communicated to the remote device via a video server configured to transmit real-time video data from the digital camera, over a secure socket connection, to the remote device.

2. The system of claim 1, wherein the camera control inputs include at least one of: a camera power input, a camera pan input, camera tilt input, and a camera focus input.

3. The system of claim 1, wherein the at least one telepresence device includes a mobile base and the at least one telepresence device includes at least one obstacle sensor input, at least one mast height control input, and at least one mobile base drive motor control input, and wherein the at least one mast height control input and the at least one mobile base drive motor control input are communicated from the remote device to the at least one telepresence device via the embedded webserver.

4. The system of claim 1, wherein the video server (a) handles and negotiates connections and distribution of a video feed from the digital camera to multiple remote devices and/or (b) uses Node.js that executes JavaScript code to enable real time transmission of data over secure socket connections.

5. (canceled)

6. The system of claim 1, wherein there is a broadcast functionality in a Node server that captures raw data from a camera sensor and handles multiplexing and encoding of the video feed to multiple remote devices.

7. The system of claim 1, wherein client functionality in a Node server accepts requests from a broadcaster and then ports the video feed to a user interface of the web browser.

8. The system of claim 1, wherein the secure socket connection comprises an encrypted socket connection.

9. A telepresence device, comprising:
a digital camera having at least two control inputs selected from: a camera power input, a camera pan input, camera tilt input, and a camera focus input;
an embedded webserver configured to receive digital camera control commands from a user interface of a remote device and provide two-way asynchronous updates with digital camera information and parameters between the digital camera and the remote device; and
a video server configured to transmit real-time video data from the digital camera, over a secure socket connection, to the remote device.

10. The telepresence device of claim 9, wherein the embedded webserver is written in a Python programming language using a micro web framework Flask.

11. The telepresence device of claim 9, wherein the embedded webserver uses (a) standard HTTP requests to receive commands from the user interface and/or (b) persistent WebSocket connections with a client to provide two-way asynchronous updates with device information and parameters.

12. (canceled)

13. The telepresence device of claim 9, wherein the embedded webserver serves the user interface as a webpage to a client.

14. The telepresence device of claim 9, wherein the user interface has two modes of operation: an observation mode and a controller mode.

15. The telepresence device of claim 14, wherein a user (a) in observation mode has access to a video feed and/or (b) in controller mode has full access to pan, tilt, zoom and focus controls of the camera.

16. (canceled)

17. The telepresence device of claim 9, wherein the secure socket connection comprises an encrypted socket connection.

18. A non-transitory computer-readable medium storing computer-readable instructions that, when executed by one or more processors, cause the one or more processors to communicate camera control data from a remote device to a telepresence device via an embedded webserver and to communicate video data from the telepresence device to the remote device via a video server, the computer-readable medium comprising:
an embedded webserver that, when executed by a processor, cause the processor to receive digital camera control commands from a user interface of a remote device and provide two-way asynchronous updates with digital camera information and parameters between a digital camera and the remote device; and
a video server that, when executed by a processor, cause the processor to transmit real-time video data from the digital camera, over a secure socket connection, to the remote device.

19. The computer-readable medium of claim 18, wherein the embedded webserver serves the user interface as a webpage to a client.

20. The computer-readable medium of claim 18, wherein the embedded server and the video server are both hosted on a single board computer.

21. The computer-readable medium of claim 18, wherein the embedded server provides instructions to the single board computer interfaces, including the I2C communication bus that sends instructions to motor controllers for camera pan, tilt, zoom and focus functionality.

22. The computer-readable medium of claim 18, wherein a telepresence device includes a single board computer having a camera serial interface (CSI), wherein video data from a digital camera image sensor is received through the camera serial interface, and wherein the single board computer encodes the video data for video transmission to a remote device via the video server.

23. The computer-readable medium of claim 18, wherein the secure socket connection comprises an encrypted socket connection.
